(19) United States
(12) Patent Application Publication
(10) Pub. No.: US 2010/0121676 A1
(43) Pub. Date: May 13, 2010

(54) METHOD AND SYSTEM FOR LOGGING IMPRESSIONS OF ONLINE ADVERTISMENTS

(75) Inventor: Ben Jackson, Solihull (GB)

Correspondence Address: HICKMAN PALERMO TRUONG & BECKER LLP/Yahoo! Inc., 2055 Gateway Place, Suite 550, San Jose, CA, 95110-1083, US

(73) Assignee: YAHOO! INC., Sunnyvale, CA (US)

(21) Appl. No.: 12/268,998

(22) Filed: Nov. 11, 2008

(51) Int. Cl. G06Q 30/00

(52) U.S. Cl. 705/10

(57) ABSTRACT

A system and method which may log a real number of views or impressions of an element within a web page, e.g., an advertisement. Instead of sending impression data to an impression logging unit by a web page server when an element is included in a web page, the invention may collect impression data at a user terminal and send the impression data to the impression logging unit when the element actually appears within a user's view port, which is the visible area of his browser window. Consequently, only what is actually seen by users, not everything that could be seen on a web page, may be logged by the impression logging unit.

### BACKGROUND

1. Field of the Invention

The present invention relates generally to online advertising, and more particularly to obtaining a real number of impressions.

2. Description of Related Art

With the growth of the Internet, online advertising is becoming more and more important for advertisers (buyers of advertisement spaces, e.g., Coca Cola™ and Nike™). One benefit of online advertising is that an advertiser may get more information about when, where and by whom its advertisement was seen. In one approach, an advertiser may be charged according to the number of times its advertisement is displayed (Pay Per Impression), and results of the advertisement may be evaluated by the number of impressions.

However, such an evaluation may be inaccurate. In currently available systems, as long as an advertisement is included in a web page, the advertiser is charged for an impression. But a web page may expand over several screens, and a user may have to scroll over all these screens to see all advertisements. When a user does not scroll over all screens of the web page, the number of impressions obtained by a currently available system may be greater than the number of times the advertisement is actually viewed by the user.

Therefore, it may be desirable to provide a system and method for logging the number of times that an advertisement is actually viewed by users, or the real number of impressions.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates an online advertisement system for logging a real number of impressions of an online advertisement according to one embodiment of the present invention.

FIG. 2 illustrates an exemplary web page having a number of elements used with an embodiment of the present invention.

FIG. 3 illustrates a method for logging a real number of impressions of an online advertisement according to one embodiment of the present invention.

### DETAILED DESCRIPTION

The present invention provides a system and method which may log a real number of views or impressions of an element within a web page, e.g., an advertisement. Instead of sending impression data to an impression logging unit by a web page server when an element is included in a web page, the invention may collect impression data at a user terminal and send the impression data to the impression logging unit when the element actually appears within a user's display, which is the visible area of his browser window. Consequently, only what is actually seen by users, not everything that could be seen on a web page, may be logged by the impression logging unit. The invention may be carried out by computer-executable instructions, such as program modules. Advantages of the present invention will become apparent from the following detailed description.

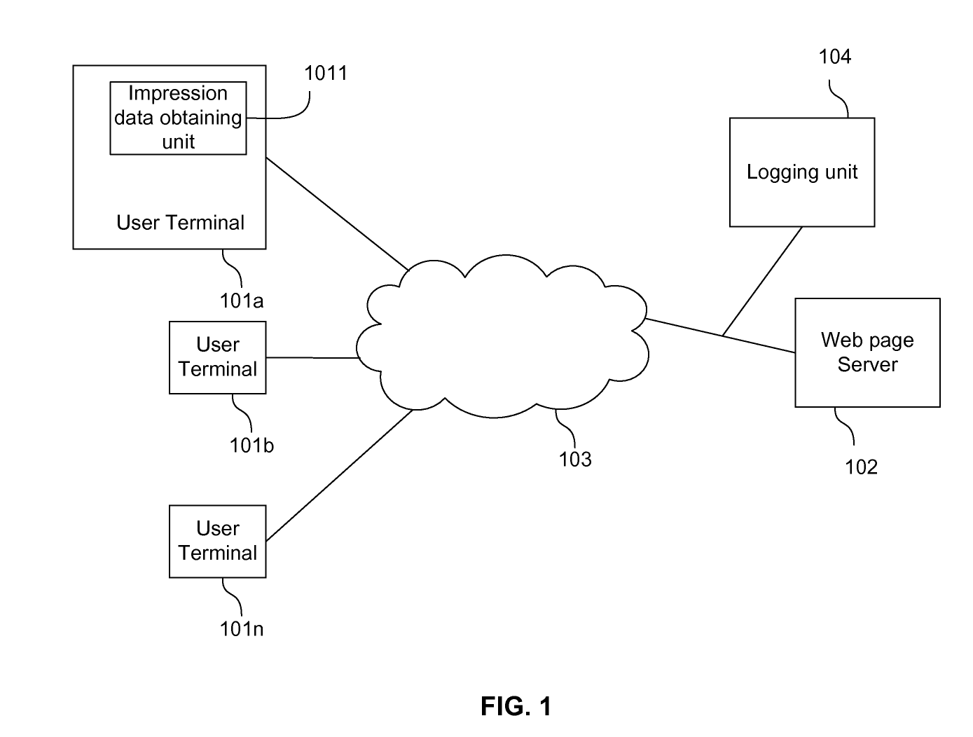

FIG. 1 illustrates an online advertisement system for logging a real number of impressions of an online advertisement according to one embodiment of the present invention. As shown, a number of user terminals 101a, 101b, . . . 101n may request web pages from a web page server 102 via a network 103, and may send, to an impression logging unit 104, impression data about what has been viewed by a user. Network connectivity may be wired or wireless, using one or more communications protocols, as will be known to those of ordinary skill in the art.

The web page server 102 may generate a web page in response to a request, e.g., an HTML (HyperText Markup Language) request, from a user terminal. The web page server 102 may include various types of elements in the web page, such as news, weather forecast, popular searches, top topics, and advertisements. The elements may be selected according to the user's configuration, the user's profile, and/or the user's interests obtained by tracking the user's browsing activities. The web page server 102 may assign each element an identifier (ID). In one embodiment, the ID is an HTML DIV tag and an element may be defined as everything contained within the HTML DIV tag, such as text, graphics, or multimedia.

The user terminal 101a, 101b or 101n may be a personal computer, a handheld or laptop device, a microprocessor-based system, a set top box, or any programmable consumer electronics. Each user terminal may be a computer system, which may include one or more of a screen, an input device, a processing unit, memory devices, and a system bus coupling various components in the computer system. An operating system of the user terminal may respond to a user input by managing tasks and internal system resources and processing system data. Each user terminal may have a browser application configured to receive and display web pages, which may include text, graphics, multimedia, etc. The web pages may be based on, e.g., HTML or extensible markup language (XML).

A user terminal may also include an impression data obtaining unit 1011, which may determine pixel dimensions and positions of an element and whether it falls totally or partially within a user's display, and send a logging request to report the impression data to the impression logging unit 104. The impression data may indicate when an element was viewed, in which web page, by which user, and for how long. In one embodiment, the impression data obtaining unit 1011 may be JavaScript™ which may monitor what is being displayed on a user's display, and report the impression data to the logging unit 104. In one embodiment, the JavaScript™ may obtain the HTML DIV tags of elements on a user's display and report the HTML DIV tags to the logging unit 104, together with the elements' amount on the user's display.

In one embodiment, the impression data obtaining unit 1011 may be JavaScript™, which is delivered to a browser in a user terminal together with a requested web page. The user terminal only needs to be JavaScript™-enabled.

In one embodiment, the impression data obtaining unit 1011 may be coded with the Yahoo User Interface Library (YUI), its document object model (DOM) collection, and its Region class. For example, a function “getRegion( )” may be used to get the area occupied by a specific DIV element, and functions “getViewportWidth( )” and “getViewportHeight( )” in the DOM class may to used to get the user's display, which may then be represented by another Region object. The area occupied by a DIV element and the user's display may be compared using Region's “union( )” and “intersect( )” functions to determine whether the element appears in the user's display or the amount of the element appearing on the user's display.

It should be understood that other programming languages or methods may be used to implement the impression data obtaining unit 1011.

To reduce the amount of data transferred between the impression data obtaining unit 1011 and the impression logging unit 104, in one embodiment, instead of reporting impression data to the impression logging unit 104 in real time, the impression data obtaining unit 1011 may check and report impression data periodically, e.g., every 50 milliseconds. The period to wait before sending the next update of impression data may be predetermined by the web page server 102.

The period to wait may be selected to further improve the accuracy of the impression data by logging impression data only when a user has been viewing an element for a reasonable amount of time, and filtering out false impressions for invalid or unwanted viewing where a user closes a browser window or moves to another page in less than, e.g., 50 milliseconds.

In one embodiment, the impression data obtaining unit 1011 may keep a list of viewed elements, and report impression data only when there are new impression data, e.g., a new viewed element or a bigger percentage amount of a viewed element. If there are no changes, e.g., when the user has not scrolled over a web page for a few seconds, or everything viewable on a web page has been viewed, then no impression data will be transmitted even when the waiting period has expired.

In one embodiment, instead of monitoring all elements within a web page, the impression data obtaining unit 1011 may only monitor impressions of some selected elements, e.g., one or more advertisements. The impression data obtaining unit 1011 may receive instructions about elements to be monitored from, e.g., the web page server 102.

The impression logging unit 104 may receive impression data from user terminals, and log the impression data. The logging unit 104 may be hardware, software or firmware, and may be internal to the web page server 102.

In one embodiment, if only a portion of an element has been viewed by a user, the impression logging unit 104 may determine whether the amount of the element appearing on the user's display has exceeded a predetermined threshold, e.g., 70%. If yes, the impression logging unit may log the element as being viewed. The predetermined threshold may be determined for each element. In one example, if an element is an advertisement and the background of the advertisement includes a number of logos of the advertiser, each occupying less than 5% of the layout of the advertisement, the threshold may be set as 5%. In another example, if the advertised product is in the center of the advertisement, the threshold may be set as 70%. The threshold may be preset by the web page server 102.

In one embodiment, the impression logging unit 104 may accumulate impression data in several transmissions from the impression data obtaining unit 1011. If the sum of unrepeated portions of an element appearing on a display exceeds the threshold for the element, the logging unit 104 may log the element as being viewed by the user.

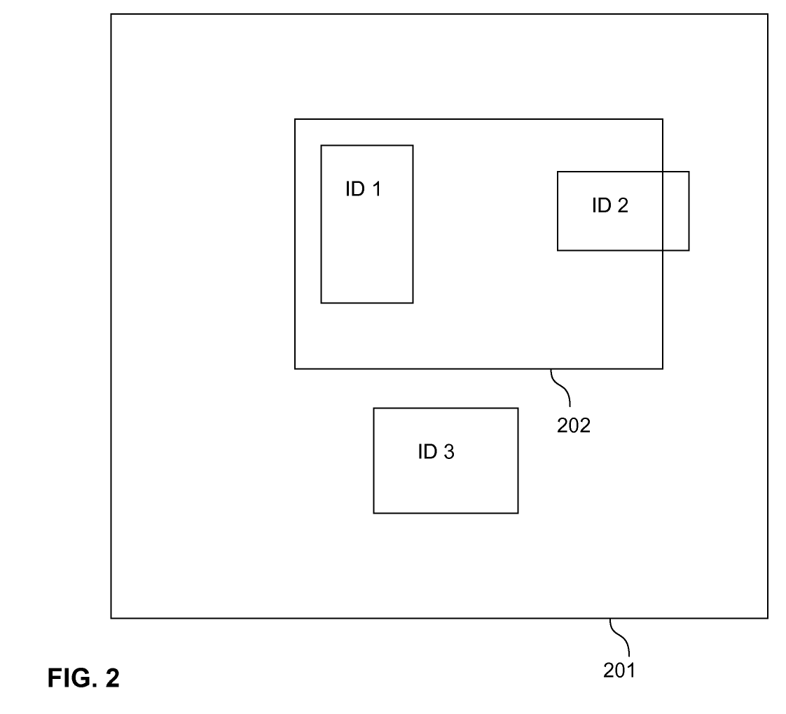

FIG. 2 illustrates an exemplary web page having a number of elements used with an embodiment of the present invention. As shown, a web page 201 may have a number of elements, each of which may be assigned a unique ID. The web page server 102 may want to track impressions of three elements, e.g., elements with IDs 1, 2 and 3. At one moment, the element 1 is completely in a user's display 202, the element 2 is partly in the user's display 202, and the element 3 is off the user's display 202 and is not visible at all. The impression data obtaining unit 1011 may send impression data to the impression logging unit 104, so that element 1 and the amount for element 2 may be logged as being viewed by the user. When the user scrolls over the web page 201, if element 2 or 3 moves into the display 202, they may be logged as being viewed by the user as well.

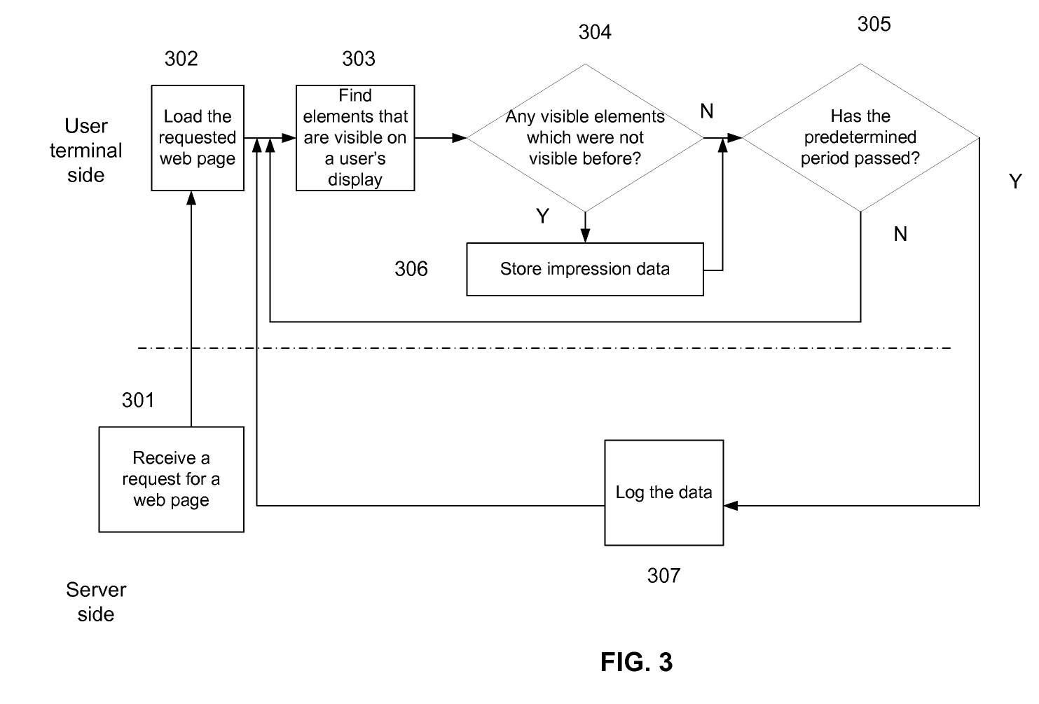

FIG. 3 illustrates a method for logging a real number of impressions of an online advertisement according to one embodiment of the present invention. The method may be used in the system shown in FIG. 1, and with the web page shown in FIG. 2.

At 301, the web page server 102 may receive a request from a user for viewing the web page 201. The request may be, e.g., an HTML request.

At 302, the requested web page 201 may be loaded into a browser in the user's terminal. The web page may include a number of elements such as news, weather forecast, and advertisements. The elements may be text, graphics, or multimedia. In one embodiment, in addition to standard content, the web page 201 may include elements targeted at the user, e.g., news about his favorite football team or advertisements. Each element may be assigned a unique ID.

The web page 201 may also carry an impression data obtaining unit 1011, which may be JavaScript™, for monitoring impressions of elements within the web page 201. The web page server 102 may configure the impression data obtaining unit 1011 to monitor impressions of certain elements within the web page 201.

At 303, the impression data obtaining unit 1011, which is loaded into the user's terminal together with the requested web page 201, may monitor a user's display to identify element(s) appearing on the user's display. In one embodiment, the impression data obtaining unit 1011 monitors impressions of an element by tracking its ID.

At 304, the impression data obtaining unit 1011 may determine whether there are new elements in the user's display which are not already seen. If there are no new elements and the impression data obtaining unit 1011 is configured to report impression data periodically, e.g., every 50 ms, the process may proceed to 305 to wait for the period to expire.

If there are new elements which have not appeared on the display before, at 306, the impression data obtaining unit 1011 may temporarily store all elements which have appeared so far. The process may then proceed to 305.

At 305, it may be determined whether it is time to send a logging request. If not, the process may return to 303 to continue to monitor elements on the user's display. Otherwise, the impression data obtaining unit 1011 may send a logging request to report the impression data to the logging unit 104.

At 307, the logging unit 104 may receive the impression data from the user terminal and log the impression data. The process may then return to 303 to continue to monitor the user's display.

The impression data may be used to analyze the result of an advertisement, or to bill an advertiser, by providing accurate data about the actual viewings an advertisement has received. The impression data may also be used to improve web page designs by finding out how many users actually scroll down to see elements at the bottom of a web page.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method for logging impressions of an element in a web page, said method comprising using a computer to perform the following:
loading the web page in a user terminal;
monitoring a display on the user terminal to collect impression data indicating whether a first element within the web page appears on the display; and
sending a logging request from the user terminal to report the impression data only if the first element has appeared on the display.

2. The method of claim 1, further comprising: logging the impression data received from the user terminal over a telecommunication network.

3. The method of claim 1, further comprising: assigning an identifier to the first element.

4. The method of claim 1, wherein the impression data further comprises information selected from the group consisting of: which user has seen the first element, and the web page on which the first element has appeared.

5. The method of claim 1, further comprising: selecting the first element as an element to be monitored.

6. The method of claim 1, further comprising: determining whether the display has any new element which did not appear before.

7. The method of claim 1, further comprising: temporarily storing impression data about the first element if it appears on the display.

8. The method of claim 1, further comprising: determining whether an amount of the first element appearing on the display exceeds a threshold, wherein the logging request is sent only if the threshold is exceeded.

9. The method of claim 1, further comprising: determining whether it is time to send the logging request.

10. The method of claim 1, further comprising: delivering a tool for obtaining the impression data to the user terminal together with the web page.

11. The method of claim 10, wherein the tool for obtaining the impression data comprises JavaScript™.

12. The method of claim 1, wherein the first element is an online advertisement.

13. A system for logging impressions of an element in a web page, the system comprising:
an impression data obtaining unit for collecting, at a user terminal, impression data indicating whether a first element within the web page appears on a display of the user terminal; and
a logging unit for receiving the impression data from the impression data obtaining unit only if the first element has appeared on the display.

14. The system of claim 13, wherein the impression data comprises information selected from the group consisting of: the element which has appeared on the display, the amount of the element which has appeared on the display, the user, the web page, and how long the element has appeared in on the display.

15. The system of claim 13, wherein the impression data obtaining unit sends a logging request to the logging unit to report the impression data.

16. The system of claim 13, wherein the logging unit logs the impression data.

17. The system of claim 13, wherein the impression data obtaining unit is delivered to the user terminal together with the web page.

18. The system of claim 13, wherein the impression data obtaining unit comprises JavaScript™.

19. The system of claim 13, wherein the impression data obtaining unit temporarily stores impression data about the first element if it appears in the display.

20. The system of claim 13, wherein the impression data obtaining unit determines whether the display has any new element which did not appear before.

21. The system of claim 15, wherein the impression data obtaining unit determines whether it is time to send the logging request.

22. The system of claim 13, wherein the impression data obtaining unit determines whether an amount of the first element which has appeared on the display exceeds a threshold.

23. A computer program product comprising a computer-readable medium having instructions which, when performed by a computer, perform a method for logging impressions of an element in a web page, said method comprising:
loading the web page in a user terminal;
monitoring a display on the user terminal to collect impression data indicating whether a first element within the web page appears on the display; and
sending a logging request from the user terminal to report the impression data, only if the first element has appeared on the display.
